(19) United States
(12) Patent Application Publication
(10) Pub. No.: US 2011/0227711 A1
(43) Pub. Date: Sep. 22, 2011

(54) General purpose wireless control system

(76) Inventor: John Robert Weimer, Stacy, MN (US)

(21) Appl. No.: 13/065,285

(22) Filed: Mar. 18, 2011

Related U.S. Application Data
(60) Provisional application No. 61/340,534, filed on Mar. 18, 2010.

(51) Int. Cl. G08C 19/16

(52) U.S. Cl. 340/12.5

(57) ABSTRACT

One embodiment of a general purpose wireless control system comprises a means for practically interfacing any type of sensor with a network capable radio, plus a means for practically interfacing any type of actuator with a network capable radio, plus a means for practically interfacing any type of controller and system monitor with a network capable radio, plus a practical economical, and secure means for establishing a radio connection, and including a wireless operating system that allows for the establishment of a secure control signal type of communication, all providing a means for solving at least one inherent problem encountered with the process or process control system.

### CROSS-REFERENCE TO RELATED APPLICATIONS

This application claims the benefit of provisional patent application Ser. No. 61/340,534, filed 2010 Mar. 18 by the present inventor.

### FEDERALLY SPONSORED RESEARCH

Not Applicable

### SEQUENCE LISTING OR PROGRAM

Not Applicable

### BACKGROUND

1. Field of Invention

This invention, the general purpose wireless control system, applies to physical process systems in general that incorporate components consisting of one or more sensors, one or more actuators, one or more controllers wherein unique properties created by a wireless connection between the components enhance the functions of the control system as opposed to merely eliminating the wired connection.

2. Prior Art

There are many applications for wireless technology today, most associated with the communications industry. The particular application of this invention started with an investigation into a means for replacing the wires in a commercial control system in an effort to alleviate the associated costs. The primary intention was to eliminate the complex control wiring employed with current control technology in an effort to cut costs. The control systems under consideration are those made up of standard sensors, actuators and a controller, all used in process control applications. The component parts of both the control system and process being controlled are typically within a short distance of each other and the controller, on the order of about twenty feet or less. In certain cases, one of the actuators could be on the order of 100 feet distant. In minor cases this one distance could be greater. It was originally thought that using a wireless connection would have potential for this longer distance wiring situation in the process control system. The guiding principle behind replacing this long distance wiring was cost containment. With the current state of technology, no other beneficial results affecting control system performance were apparent.

Surprisingly, it was discovered that a wireless connection had the opposite effect, actually increasing the costs, while at the same time creating many new problems associated with communications and reception over the wireless connection. Any savings in wiring costs were more than offset by the added cost of the radio, antennae and associated circuitry. Even more, there existed no wireless means available to interface to the particular actuator impacted by the long distance wiring in the control system. It appeared a dead end had been reached, with no practical wireless solution available to remedy this particular problem, until some interesting discoveries were made.

There are certain features associated with simple process control applications that employ wired connections which are not shared by wireless counter parts. A control system with wired connections provides access to a myriad of vendors and options for sensors and actuators that would readily satisfy every specific need of that system. There are also many readily available connection options and communication means between the sensors, actuators and controllers that make up the complete control system. In actuality, the only real issue concerning the design and implementation of a typical wired control system would revolve around the design of the control function itself. The exact opposite case exists for the wireless implementation.

There are few sensor options available with a wireless interface. There are even fewer options when it comes to actuators. An available wireless interface to a motor drive, for example, is nonexistent. The industry focus is dominated by wireless phone or communication type applications, which are not well suited to standard, simple control systems. The current focus of current wireless control system technology is essentially limited to monitoring control system operating conditions in some process or building, or for monitoring security operations. Nothing is readily available for simple feedback control type applications. Remote controlled devices and radio controlled toys are available, but that technology has no applicability to feedback controlled process applications. Relatively simple control systems employing short distance control wiring have no need for or do not benefit from a simple replacement of the control wiring with radios. In order to employ radio connections, there would need to be some additional overriding benefits to their usage. Those benefits do not exist today. Wireless control applications today tend to be highly specific, custom designs, rather than off the shelf, ready to integrate solutions. It is difficult to justify the costs associated with the custom engineering support normally required with the current implementation of a wireless control system.

One reason for requiring custom engineering support is the lack of a clean communication methodology. There are many methods and protocols available for establishing the radio connections in a wireless system, but there is no straight forward way to handle the information transmitted over that radio network. Control signal communication is different than the usual types of communication carried out over current wireless networks. The current focus of wireless technology is voice and data communication as with wireless phone service or computer networks, not the peculiarities of system signals.

To sum up, there is currently no practical economic value in replacing the short wired connections in a simple feedback control system with a radio connection. There is no readily applicable communication protocol to handle all the signals between the sensors, actuators controllers in a simple feedback control application. There are no problems associated with a short wired connection in a simple feedback control application that can be addressed by a radio connection. To make the replacement of control wiring with a radio connection a viable option would require a total system solution that is completely reliable, is affordable, and most importantly will solve some overriding problem associated with this application. This does not exist at this time.

### SUMMARY

In accordance with one embodiment, a general purpose wireless control system comprises a means for practically interfacing any type of sensor with a network capable radio, plus a means for practically interfacing any type of actuator with a network capable radio, plus a means for practically interfacing any type of controller and system monitor with a network capable radio, plus a practical economical, and secure means for establishing a radio connection, and including a wireless operating system that allows for the establishment of a secure control signal type of communication, all providing a means for solving at least one inherent problem encountered with the process or process control system.

### DRAWINGS—FIGURES

FIG. 1 shows a key circuitry element common to all electronics of this invention.

FIG. 2 shows the data packet architecture used for this invention.

FIG. 3 shows an example application demonstrating the key features of this invention.

FIG. 4 shows section 1 of 5 for the wireless electronics for one type of sensor actuator interface including that of a stabilizing damper controller/boiler interface.

FIG. 5 shows section 2 of 5 for the wireless electronics for one type of sensor actuator interface including that of a stabilizing damper controller/boiler interface.

FIG. 6 shows section 3 of 5 for the wireless electronics for one type of sensor actuator interface including that of a stabilizing damper controller/boiler interface.

FIG. 7 shows section 4 of 5 for the wireless electronics for one type of sensor actuator interface including that of a stabilizing damper controller/boiler interface.

FIG. 8 shows section 5 of 5 for the wireless electronics for one type of sensor actuator interface including that of a stabilizing damper controller/boiler interface.

FIG. 9 shows section 1 of 4 for the wireless electronics for another type of sensor actuator interface including that of a 3 phase motor drive interface.

FIG. 10 shows section 2 of 4 for the wireless electronics for another type of sensor actuator interface including that of a 3 phase motor drive interface.

FIG. 11 shows section 3 of 4 for the wireless electronics for another type of sensor actuator interface including that of a 3 phase motor drive interface.

FIG. 12 shows section 4 of 4 for the wireless electronics for another type of sensor actuator interface including that of a 3 phase motor drive interface.

FIG. 13 shows section 1 of 4 for the wireless electronics for another type of sensor actuator interface including that of a pump control/temperature sensor.

FIG. 14 shows section 2 of 4 for the wireless electronics for another type of sensor actuator interface including that of a pump control/temperature sensor.

FIG. 15 shows section 3 of 4 for the wireless electronics for another type of sensor actuator interface including that of a pump control/temperature sensor.

FIG. 16 shows section 4 of 4 for the wireless electronics for another type of sensor actuator interface including that of a pump control/temperature sensor.

FIG. 17 an electronic circuit board layout for the electronics of the stabilizing damper/boiler interface.

FIG. 18 shows a key code fragment illustrating characteristics of this invention.

FIG. 19A shows a top view of the cabinet for housing the electronics of this invention.

FIG. 19B shows a side view of the cabinet for housing the electronics of this invention.

FIG. 19C shows a front view of the cabinet for housing the electronics of this invention.

FIG. 20 shows a perspective 3D view of the cabinet for housing the electronics of this invention stabilizing damper.

FIG. 21 illustrates a signal flow diagram of a basic feedback control system.

FIG. 22 shows the main screen of a software application for this general purpose wireless control system.

FIG. 23A show the pull up screen for the control system setup feature of the software application for this general purpose wireless control system.

FIG. 23B show another aspect of the pull up screen for the control system setup feature of the software application for this general purpose wireless control system.

FIG. 24 shows an example pull up install screen of a software application.

FIG. 25 shows an example pull up uninstall screen of a software application.

FIG. 26 shows an example pull up edit screen of a software application.

FIG. 27 shows an example controller install screen of a software application.

FIG. 28 shows an example pull up port install screen of a software application.

FIG. 29 shows an example edit screen of a software application.

FIG. 30 shows an example install screen for a sensor of a software application.

FIG. 32 shows an example run time screen of a software application.

### REFERENCE NUMERALS

LED1 Light emitting diode
S1 Momentary contact push button switch
U1 Microcontroller
302 First boiler
303 Second boiler
304 Third boiler
305 Boiler stabilizing damper with wireless controller for first boiler
306 Boiler stabilizing damper with wireless controller for second boiler
307 Boiler stabilizing damper with wireless controller for third boiler
308 Wireless connection to main system pump with temperature sensor
309 Wireless connection to DHW pump with temperature sensor
310 Wireless connection to breach pressure sensor
311 Chimney section of boiler flue system
312 Breach section of boiler flue system
313 Wireless connection to flue third exhauster fan
314 Wireless connection to flue second exhauster fan
315 Wireless connection to flue first exhauster fan
316 First exhauster fan
317 Second exhauster fan
318 Third exhauster fan
319 Wireless connection to outdoor temperature sensor
320 Wireless main controller
1701 Location of radio chip on circuit board
1702 Location of antenna on circuit board
1901 Antenna
1902 Mounting tab
1903 Clear box cover
1904 Example circuit board in box, top view
1905 First view center mounting plate
1906 Antenna location on board in box
1907 Bottom access hole in box
1908 Pressure transducer in box
1909 Antenna
1910 Example circuit board in box, side view
1911 Front access opening in mounting plate
1912 Electronic board standoff
1913 Side access opening in mounting plate
2001 Main box section
2002 Clear box access cover
2003 Antenna in box

### DETAILED DESCRIPTION

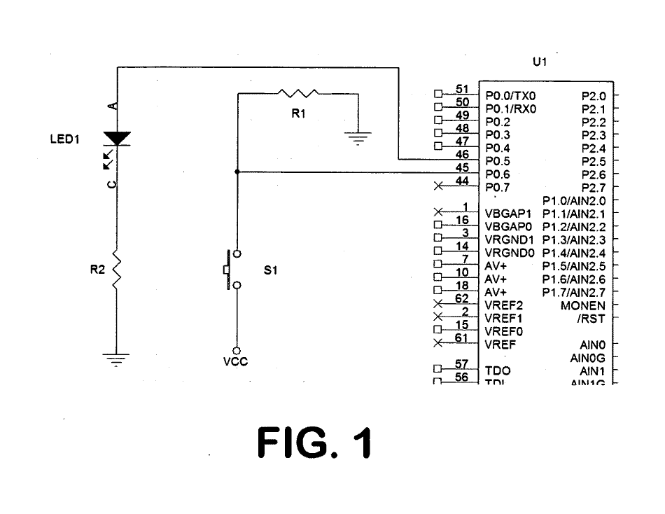

### FIGS. 1, 2, 4C, and 5—Preferred Embodiment

The description of this invention is presented in 3 parts. The first part describes the type of radio connection. The second part presents the hardware of this invention. The third part describes the radio board enclosure.

The current embodiment of this invention incorporates the Wi.232FHSS radio module on the electronic boards. It employs a frequency hopping spread spectrum transmission with a carrier sense multiple access protocol. The radios in the system are configured for broadcast communication in the 902-928 MHz frequency band. The radios in any specific control system are configured in a master/slave protocol. The master and slave assignment depends on the specific control function of the particular control device incorporating the radio. This embodiment of the invention uses either ½ wave dipole or ¼ wave whip antennas, with the ½ wave dipole antenna preferred for best reception.

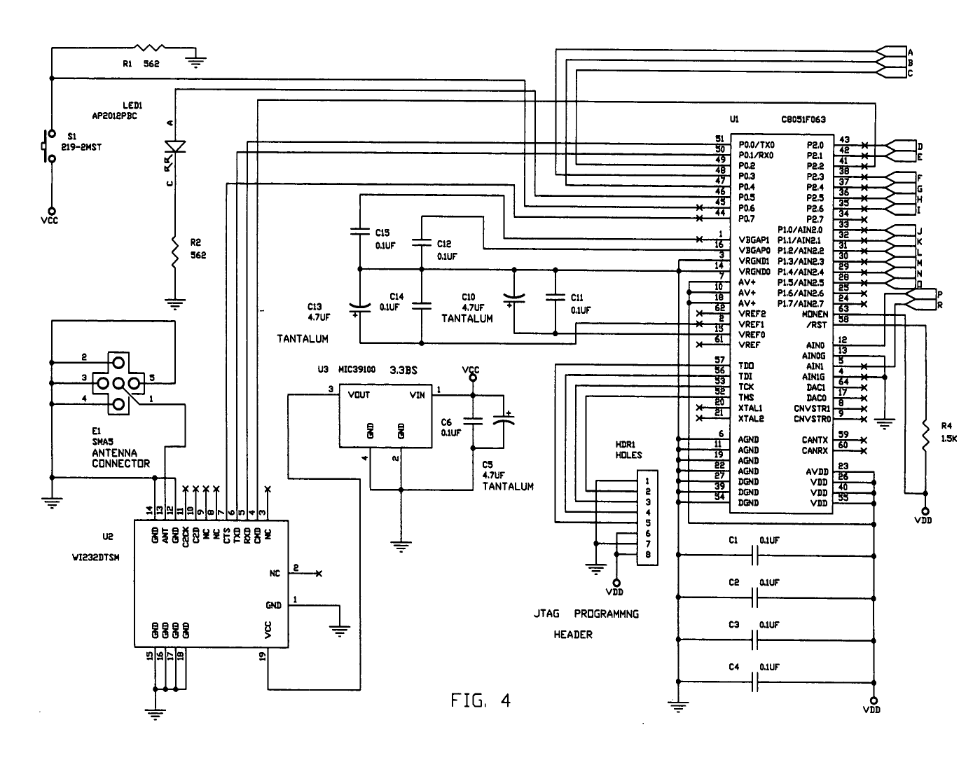

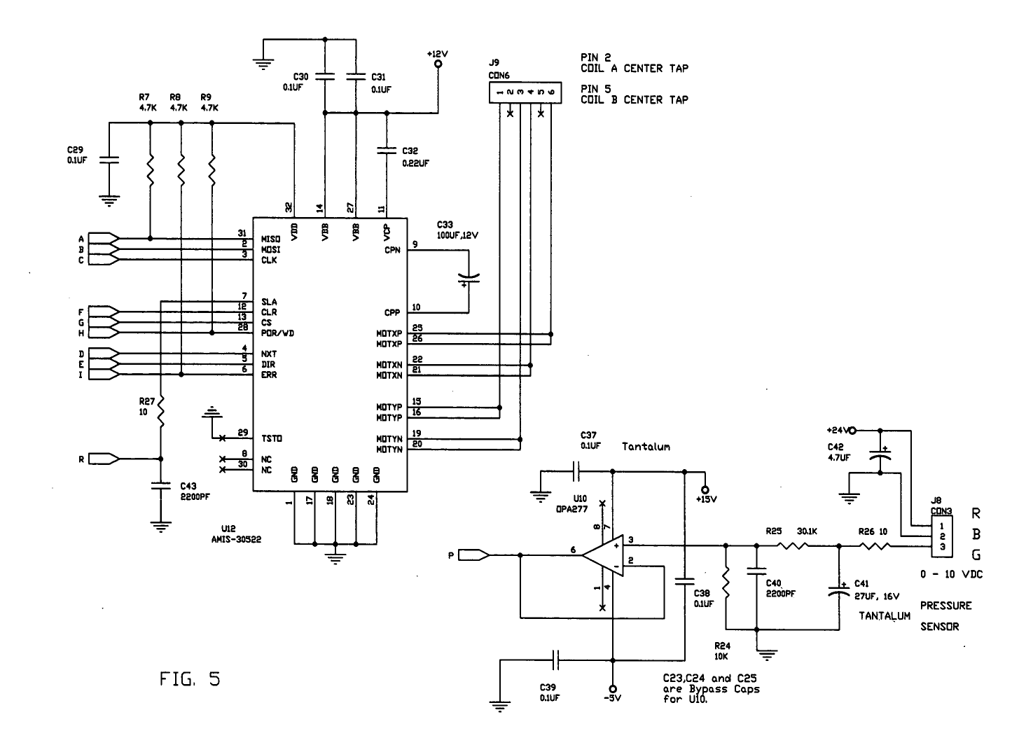

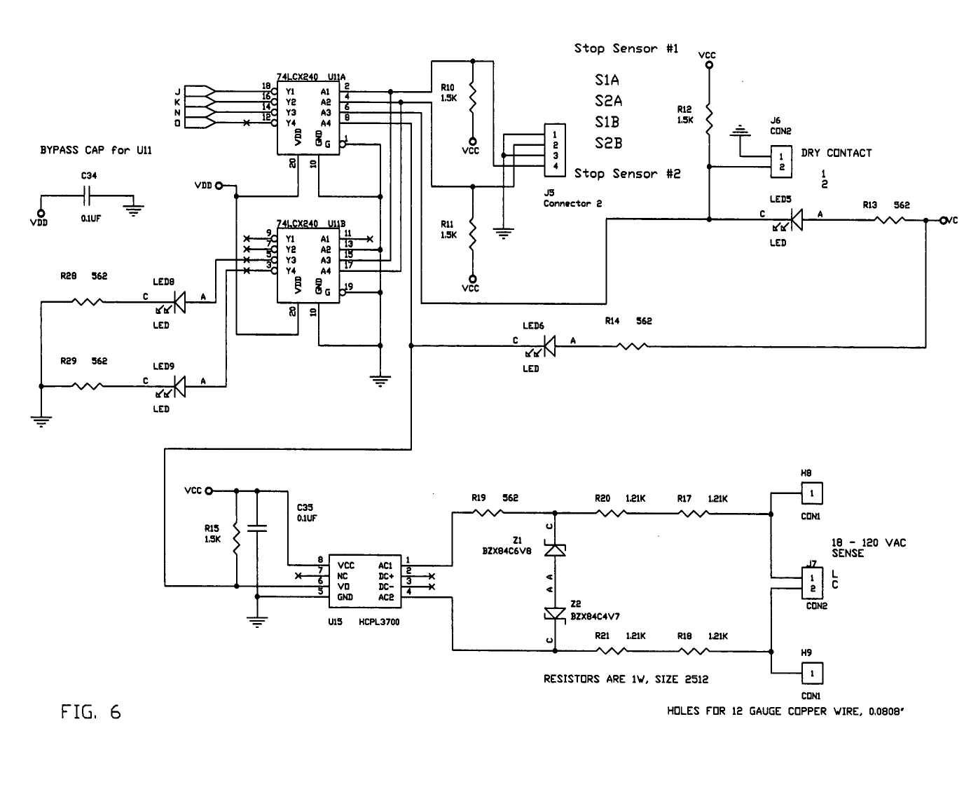

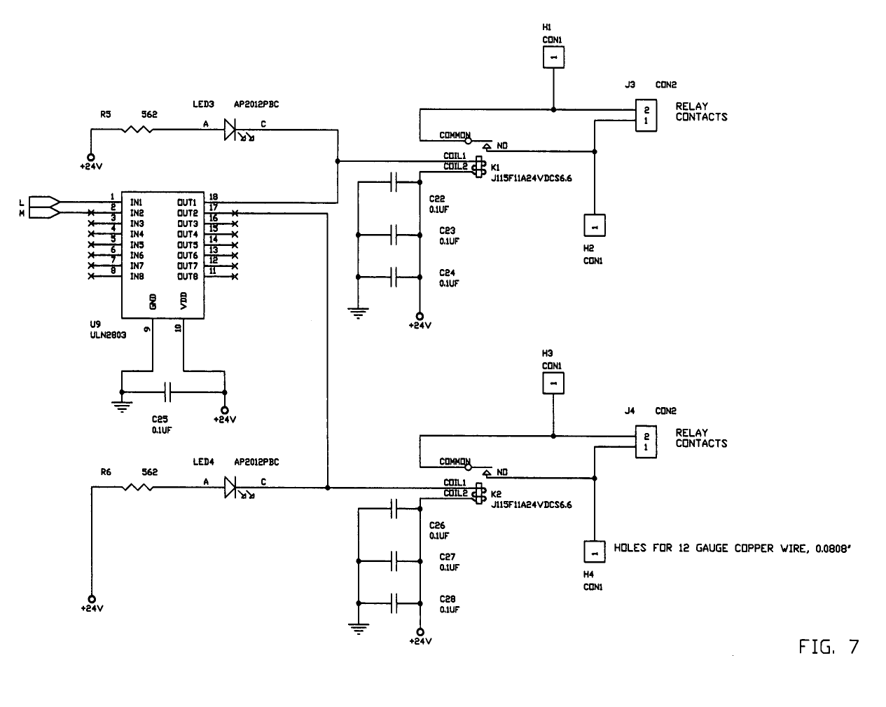

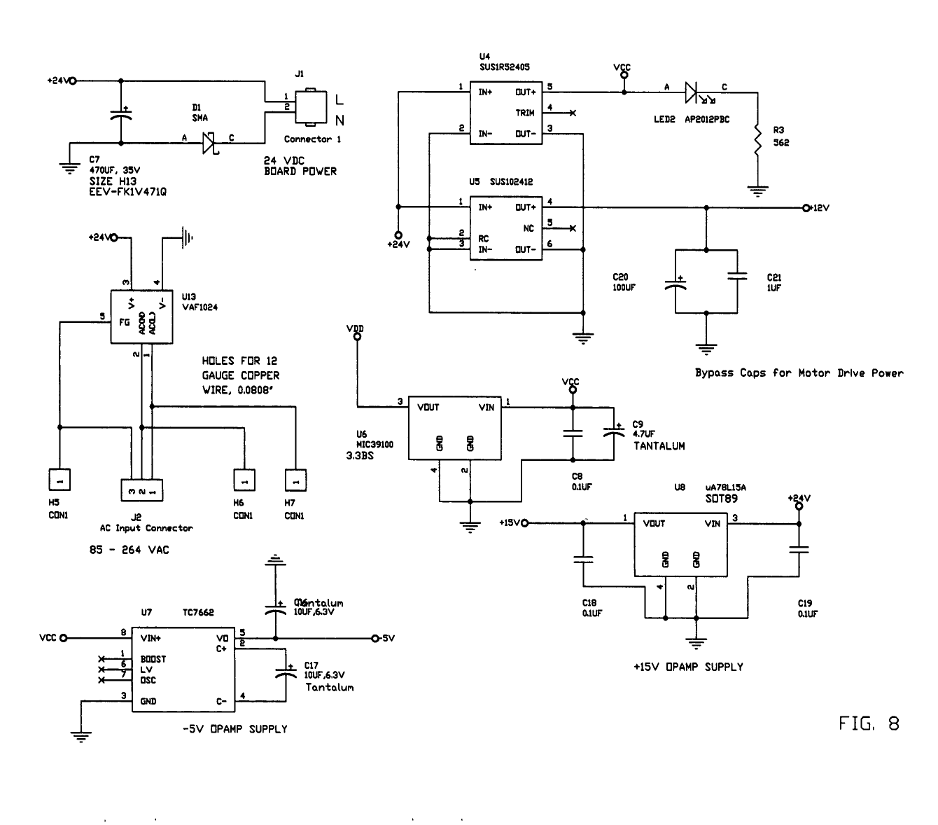

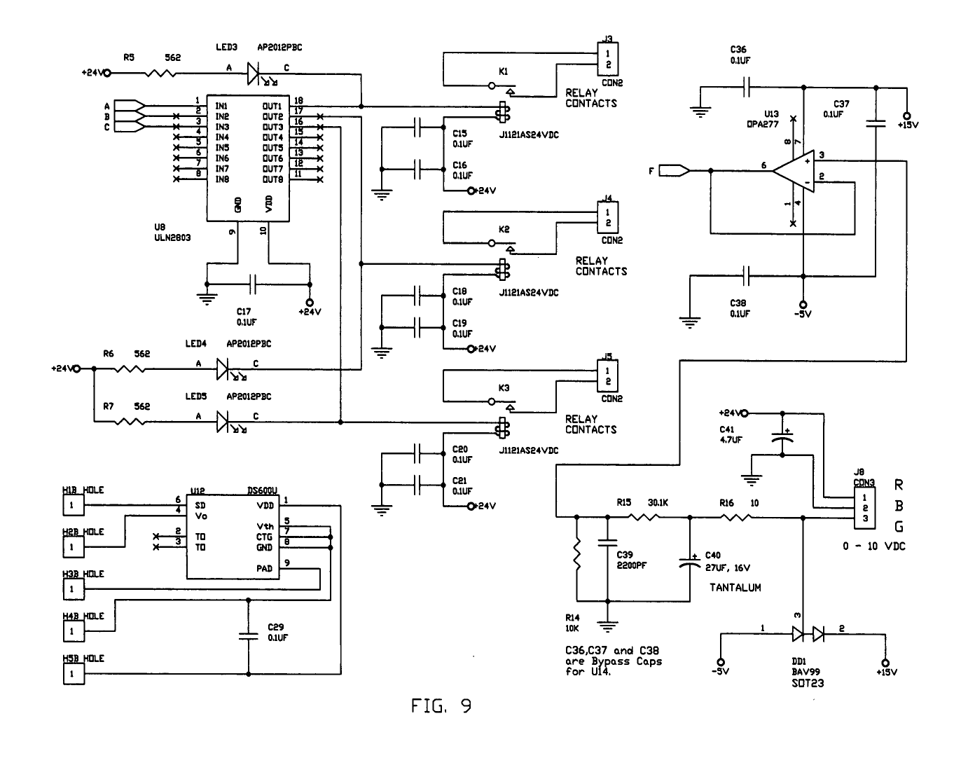

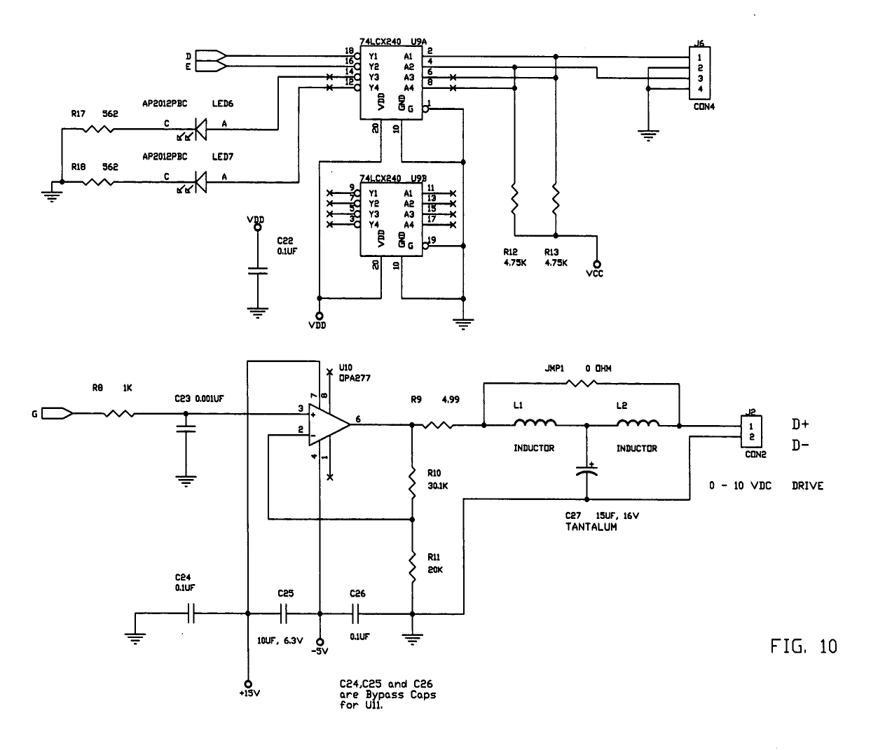

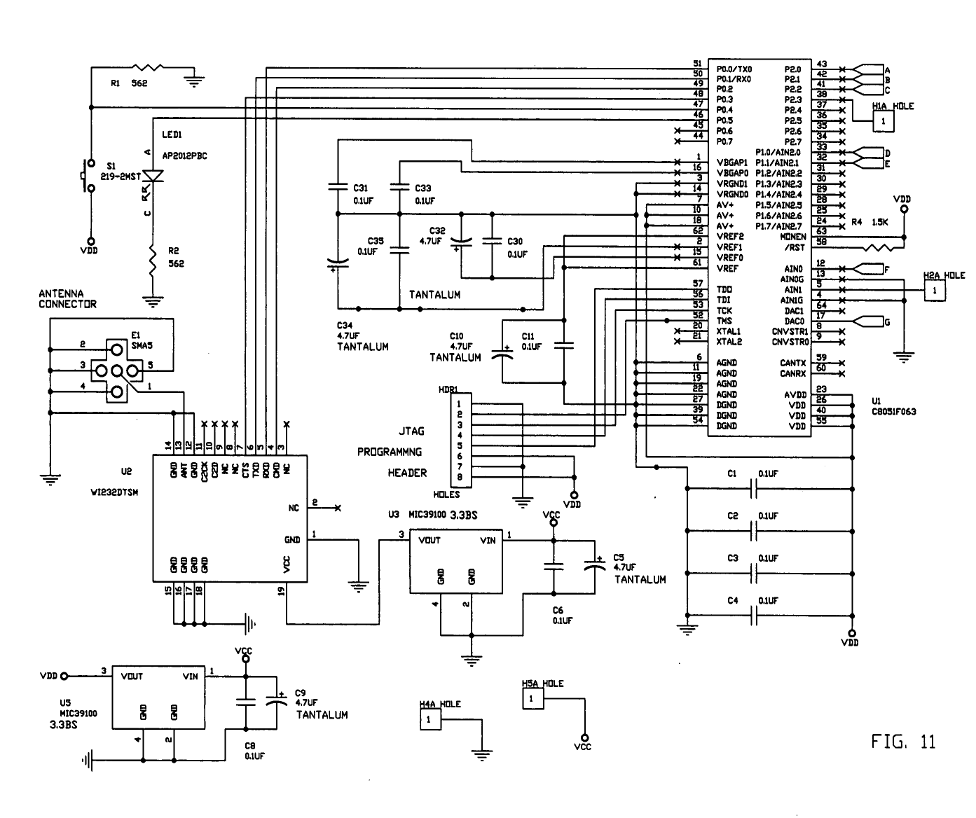

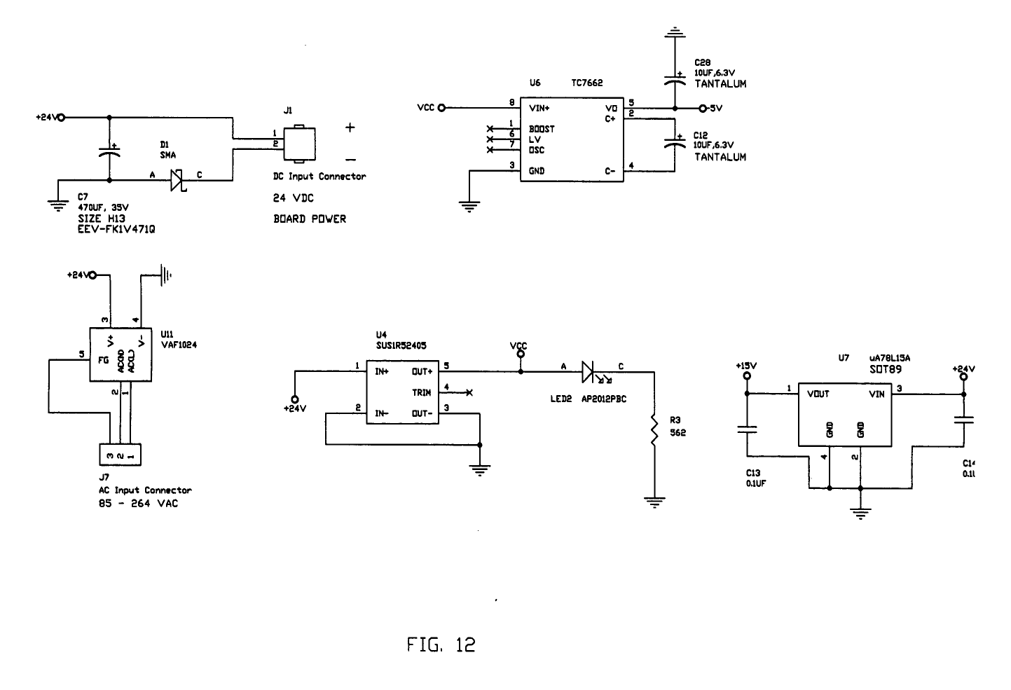

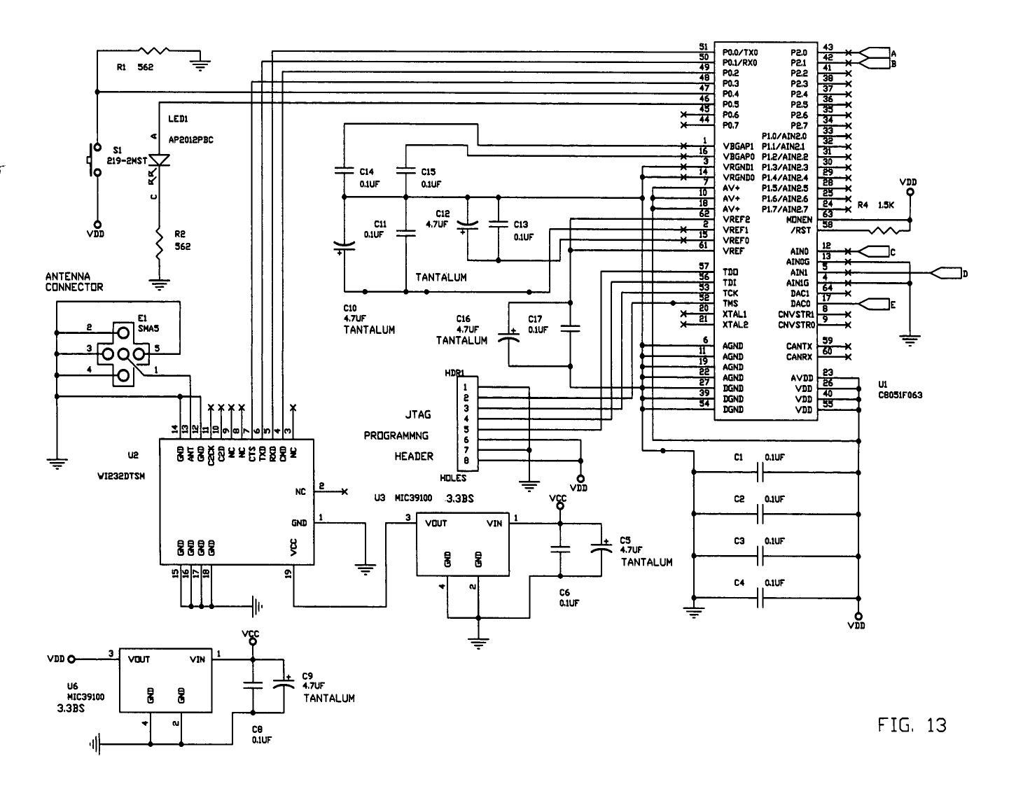

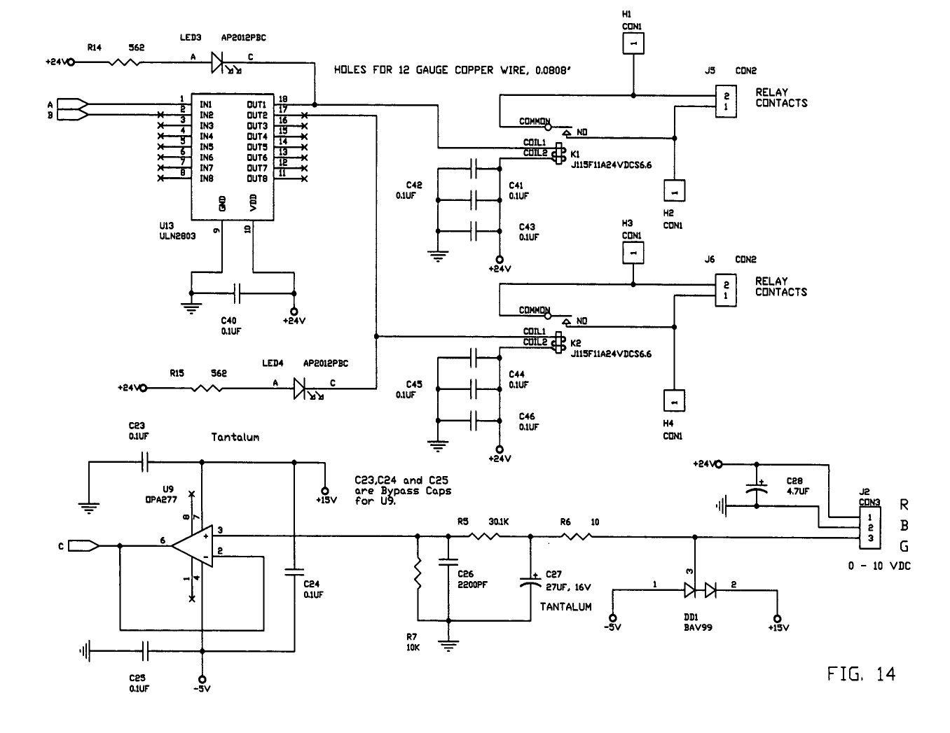

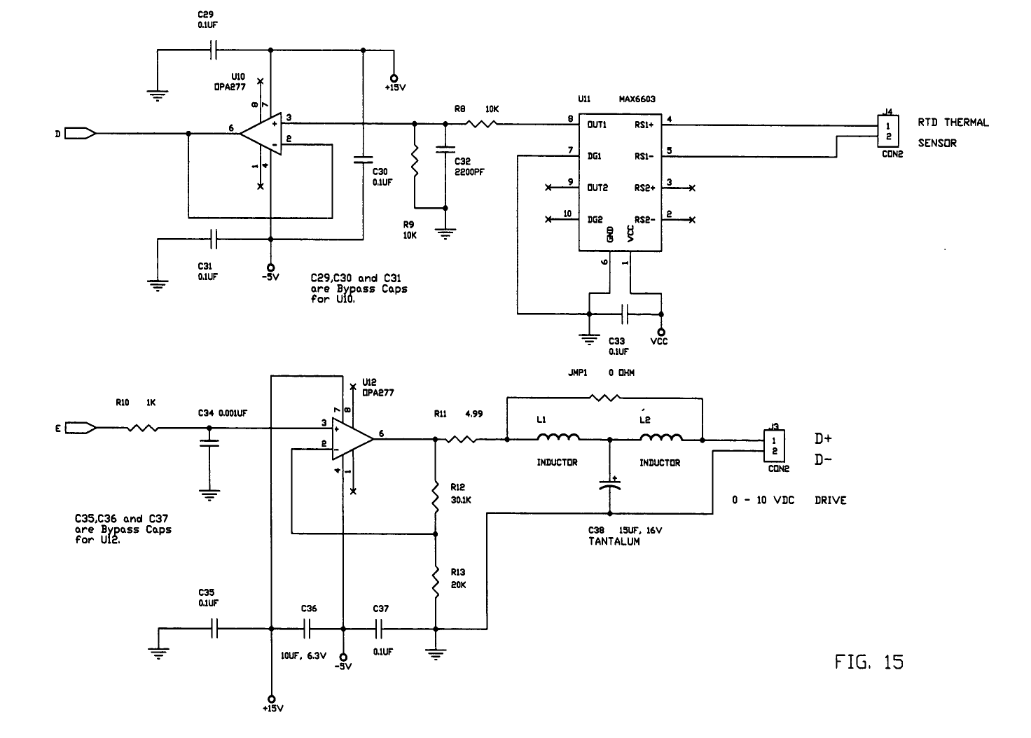

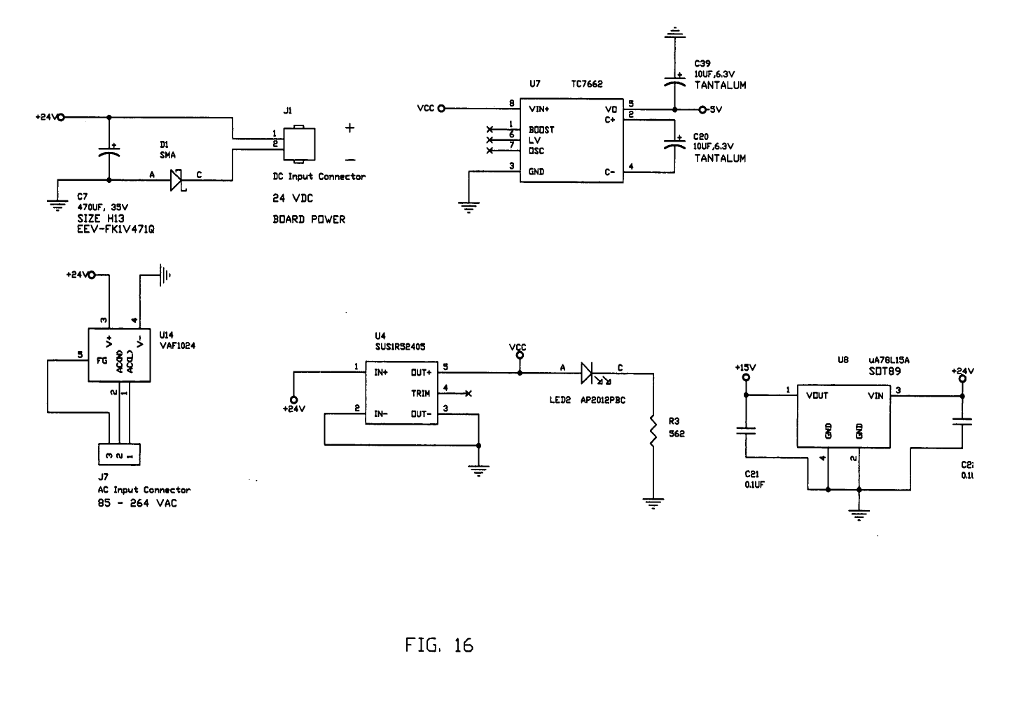

FIG. 1 shows a key circuit element with key circuit components common to all of the electronics of this invention. The components are an LED (LED1) and a momentary contact push button switch (S1), both connected to a microcontroller (U1). FIG. 4 through FIG. 8 are the circuitry of one type of wireless board of this invention that incorporates a stepper motor drive capability, position sensing, 18-120VAC sensing, relays and a 0-10VDC analog sensor. FIG. 9 through FIG. 12 are the circuitry of another type of wireless board of this invention that incorporates switch closure sensing, relays, a temperature sensor, a 0-10VDC analog drive, and a 0-10VDC analog sensor. Although this board has multiple uses, it is capable of acting as a general purpose 3 phase motor drive interface for the radio network. FIGS. 13 through FIG. 16 are the circuitry of another type of wireless board of this invention that incorporates relays, a temperature sensor, a 0-10VDC analog drive, and a 0-10VDC analog sensor. Although this board has multiple uses, it can act as a combined pump control and temperature sensor with a radio interface to the wireless control system. By using the simple technique of custom populating these boards with the electronic parts specific to a particular product application, different electronic boards can easily be created that satisfy the unique requirements of different control systems.

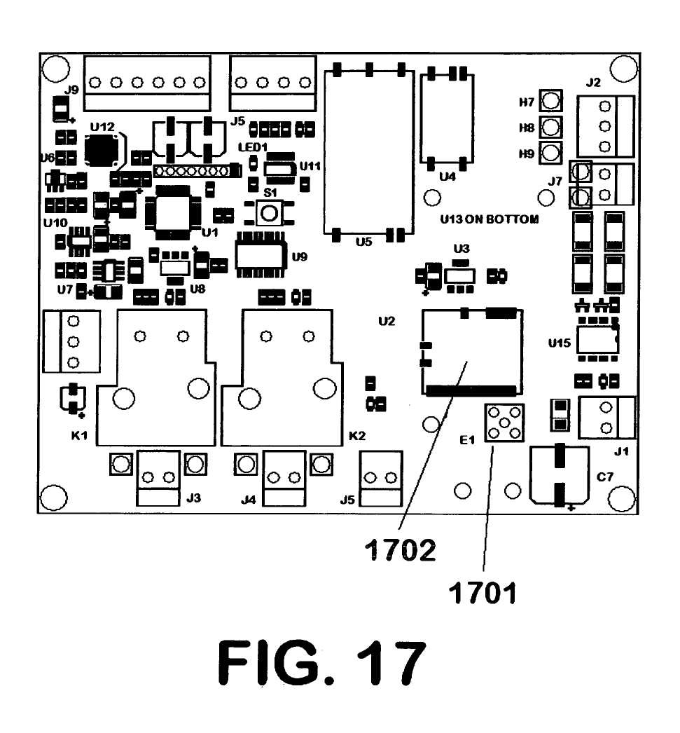

FIG. 17 is the board layout for the circuit schematics for FIG. 4 through FIG. 8. It shows the position of the radio module (1702) and the antenna (1701), which are kept in the same relative location with respect to the board mounting holes on all of the electronic boards in this embodiment of the invention. This simplifies the implementation of the invention by enabling the use of one common enclosure for all the possible applications in various control systems.

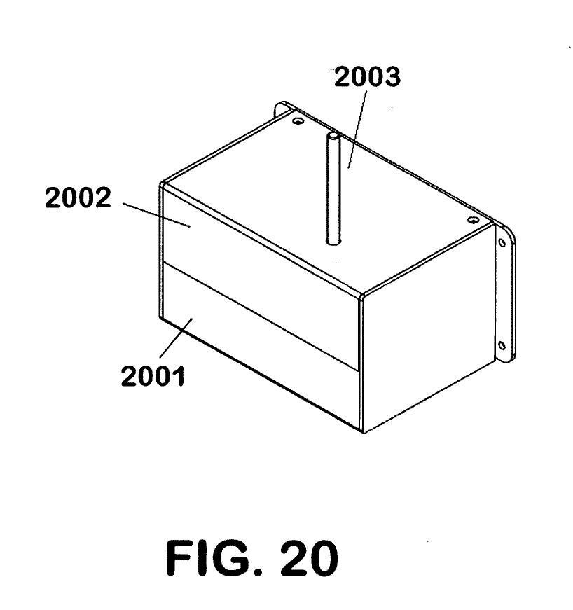

One embodiment of this invention uses a common universal enclosure for the electronics. FIG. 20 is a perspective 3D view of the enclosure. It is made of plastic to allow for unimpaired radio reception. It shows the ½ wave dipole antenna (2003) that protrudes through a small hole in a clear removable enclosure top (2002). The removable top allows for complete access to the inside of the enclosure. The remainder of the enclosure (2001) in this embodiment is opaque.

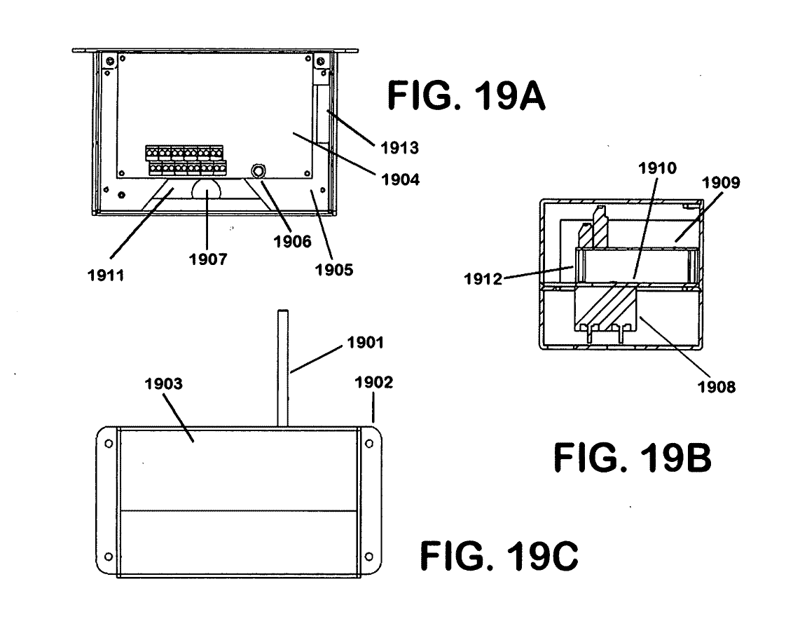

FIG. 19A shows the enclosure with the internal parts from a top view. FIG. 19B is the enclosure plus internal parts from a side view. FIG. 19C is the enclosure from a front view. The unique features of this enclosure, and its application to this wireless control concept, are illustrated in FIG. 19B. The enclosure has 2 cavities, top and bottom divided by a removable mounting plate (1910). The top of the plate is for mounting the wireless electronic boards (1909) in the enclosure. The bottom of the plate is capable of mounting different types of components associated with the board function such as sensors. This example shows a pressure transducer (1908) attached on the bottom. It is a simple procedure to connect the wiring from the sensor module to the analog sensor circuitry of the wireless board. A unique feature of this invention is the ability to employ any type of sensor or actuator in this wireless control system. This allows for a clean implementation of the individual control components of the control system. The enclosure was designed to allow for standoffs (1912) to be employed with the board and mounting plate to allow room for electronic parts to be mounted on both the bottom and the top of the circuit boards. Another example board (1904) is shown in FIG. 19A with the mounting plate (1905). There are openings in the mounting plate (1911 and 1913) that allow wiring to pass between the bottom and top cavities of the enclosure. This enables external parts, such as the example pressure transducer, to be included with the wireless electronics in one simple enclosure. There are round mounting holes (1907) in the bottom and back of the box and mounting tabs (1902) that allow the simple mounting of the enclosure containing the wireless component. Unused holes are plugged with plastic conduit style hole plugs. Mounting tabs (1902) are positioned toward the back of the enclosure along both sides, and act as another means for mounting the wireless components into the control system. The ½ wave dipole antenna (1901) in FIG. 19C is shown protruding from the top of the enclosure. A hole in the cover (1903) allows the antenna to extend outside the enclosure reducing potential interference to the radio signal, and eliminating wasted space inside the enclosure. The location of the antenna (1906) is shown relative to the box corners, and is located on the board such that it is always in the same relative location inside the enclosure when the board is mounted, irrespective of the electronic board type. The intent is to eliminate potential radio reception problems when mounting the enclosure into the system, and to simplify installation of the wireless control components.

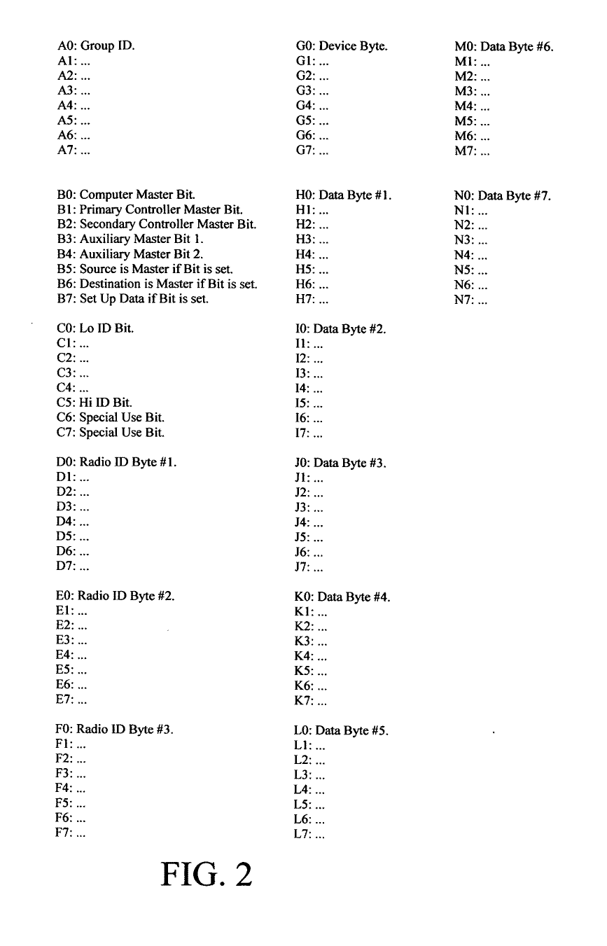

### Operation—FIGS. 2, 3, 18, 21, 22, 23A and 23B

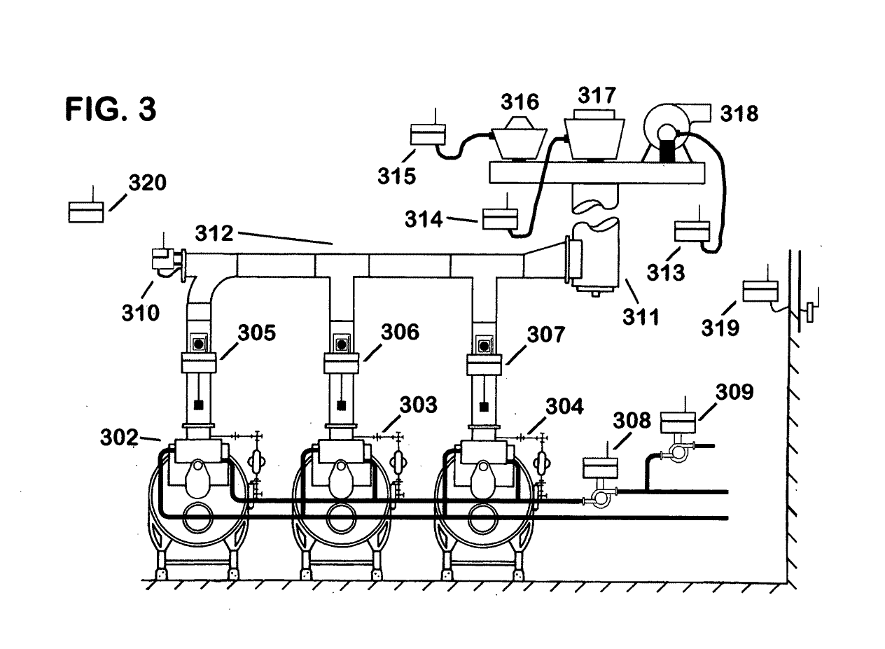

FIG. 3 is an example of an application of the wireless control system of this invention that will be used to illustrate the unique advantages and features afforded by this invention. This is an example of a boiler room with a wireless boiler room control system of this invention. This boiler plant contains three boilers (302, 303, 304) with an hydronic heating system using a wireless connection to the system pump with temperature sensor (308) and a similar connection to a domestic hot water pump with temperature sensor (309). This boiler system also has wireless connections to the boilers with stabilizing dampers (305, 306, 307). This system has a common breach (312) and chimney (311). The flue system uses mechanical venting with three different venting fans (316, 317, 318) from three different manufacturers. Each fan has a wireless drive interface (315, 314, 313). There is a wireless outdoor temperature sensor (319) and a wireless main controller (320).

The uniqueness of this invention originates with a shift in the focus of the application of wireless technology. Current approaches focus on replacing the wires in a system with radios. This invention began with a focus on replacing the connectors on the control board with a radio. When designing any control board, the connectors are the limiting factor. There are practical limits to how many and what type of connectors can be designed into an electronic circuit board. This in turn limits the final applicability of the controller and thus the control system. If these limitations can be removed, the capabilities of the controller and the resulting control system can be greatly expanded. Now consider one more aspect of a wireless link. RF links have very different communications considerations than wired links. A wire can communicate a DC voltage, whereas an RF link cannot. The straight RF link is more limiting than a wired link. If some form of wireless operating system capable of eliminating the communications limitations of the RF link is combined with the concept of replacing connectors with a radio, new useful features can be economically incorporated into a wireless control system not available to a wired system. Now a wireless control system has the potential to replace its wired counterpart, even when strict replacement of wires is not economical or practical.

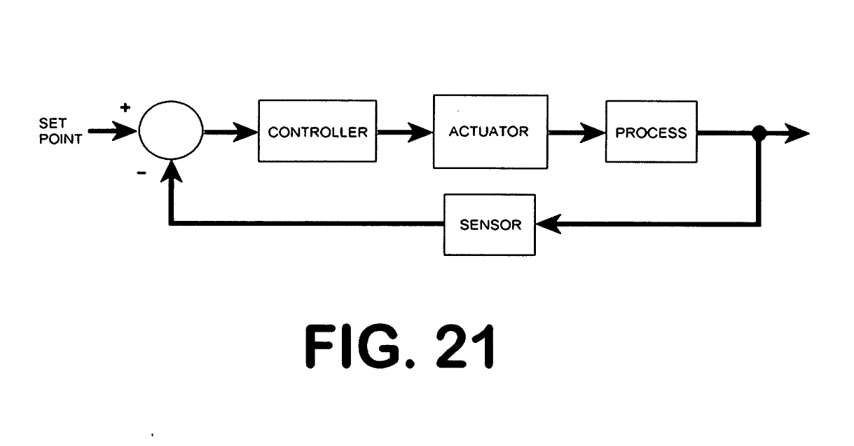

FIG. 21 shows a signal flow diagram for a typical feedback control system. All control systems can be viewed from this perspective. They all have some process that uses an actuator in some way to change the operating conditions of the process. The actuator receives a signal from a controller which incorporates a set point comparator. The comparator of the controller receives its signal from a sensor which senses the property of the process that needs to be controlled. When considering a radio configuration, also consider that sensors and actuators only communicate with a controller, not with each other. As communications go, they are radio slaves. A controller communicates with all components and is therefore a radio master. In a master/slave radio architecture slaves can only communicate with masters, not with each other, and there only needs to be one controller in the system. Using a master/slave communication architecture greatly simplifies the communications in a wireless control system.

Now consider the signals in a control system. All systems can be defined by the system properties. Pressure and temperature are examples of system properties. The signals of any general purpose control system are uniquely the properties of the system which are referred to as variables. In communicating between the elements of a control system, the control signals need only be the variables inherent to that system. All that needs to be communicated as a signal from the sensors to the controller and then to actuators are the properties.

Now consider FIG. 2. This shows the 14 byte communications data packet of this invention. All devices in the wireless control system communicate via this data packet. It starts with an 8 bit group ID, which is byte A of the data packet. The next byte (B) of the packet identifies the type of master associated with the packet, if any, and whether the information is setup data or a control signal. The control signals are the system variables. The next byte (C) is a unique ID byte that identifies the source of the signal that a radio receives. Remember, in this communication architecture slaves (sensors and actuators) cannot communicate with each other. Bytes D, E, and F are the unique ID of the radio on the wireless electronic board. This is the MAC address of the radio. It is locked to the firmware of the radio and cannot be changed. Byte G is the device byte that uniquely identifies the type if device interfaced to the radio. The last 7 bytes, H through N are the data bytes uniquely encoded to match the device type byte. Knowing the device type allows the data packets to be decoded.

Following are some examples of the data architecture of this invention that apply to the example system of FIG. 3. Referring to FIG. 2, these are bytes G through N of the data packet. The first byte of these examples is the unique device ID:

Data Structure for Dampered Heating Unit Single Stage:
/00000110/ssssssss/ssssssss/pppppppp/pppppppp/nnnnnnnn/0000000a/
00000000/
s - set point pressure hi and lo byte.
p - actual pressure hi and lo byte.
n - number of decimal places.
a - stage # 1 ON/OFF (1/0).
Data Structure for Dampered Heating Unit Multi Stage:
/00000111/ssssssss/ssssssss/pppppppp/pppppppp/nnnnnnnn/0000dcba/
00000000/
s - set point pressure hi and lo byte.
p - actual pressure hi and lo byte.
n - number of decimal places.
a - stage # 1 ON/OFF (1/0).
b - stage # 2 ON/OFF (1/0).
c - stage # 3 ON/OFF (1/0).
d - stage # 4 ON/OFF (1/0).
Data Structure for Pressure Sensor:
/00000001/pppppppp/pppppppp/nnnnnnnn/00000000/00000000/00000000/
00000000/
p - actual pressure hi and lo byte.
n - number of decimal places.
Data Structure for Breach Pressure Sensor:
/00100001/pppppppp/pppppppp/ssssssss/ssssssss/nnnnnnnn/00000000/
00000000/
p - actual pressure hi and lo byte.
s - set point pressure hi and lo byte.
n - number of decimal places.
Data Structure for Temperature Sensor :
/00000010/tttttttt/tttttttt/0000000f/nnnnnnnn/00000000/00000000/
00000000/
t - actual temperature hi and lo byte.
f - Fahrenheit or Centigrade (1/0)
n - number of decimal places.
Data Structure for Outdoor Temperature Sensor:
/00100010/tttttttt/tttttttt/0000000f/nnnnnnnn/00000000/00000000/
00000000/
t - actual temperature hi and lo byte.
f - Fahrenheit or Centigrade (1/0)
n - number of decimal places.

Now define the wireless operating system of this invention. Begin with the setup of a wireless control system using an operating system as embodied in this invention. All control systems follow a format based on the signal flow diagram of FIG. 21. Also, refer to the data packet of FIG. 2. Assume, for example, a pressure controlled process composed of the process, a pressure sensor (the sensor component), a speed controlled fan that provides a variable air volume to the process (the actuator) and a controller. Following the concept embodied in FIG. 21, the control system is composed of three and only three components; the sensor, the actuator, and the controller. These components constitute a complete system group. When the control system is first set up with virgin components, a unique group ID is assigned and programmed into the firmware of the component. A virgin component has by default a group ID of zero. If any of the setup functions of any control component are altered, the group ID must simultaneously be changed. When communicating with components in the control system, only components with a common group ID can communicate with each other. This is one measure to assure secure system operation. There are two operating modes for each component and is part of the firmware of each component; a set up mode and a function mode. In setup mode, the operating system parameters are programmed into the firmware of the component. These parameters are bytes A through G of the data packet shown in FIG. 2. Each component of the control system has a unique function defined by the physical control functions of the control system, and the group ID. All components within the control function defined by the group ID are assigned a unique device ID, bits 0 through 5 of byte C in FIG. 2. In order to communicate as part of the wireless control system, you must have a valid device ID and be part of the group. Associated with all radios in their firmware, and unique to all radios is the MAC address. When setting up the wireless control system, the MAC address is assigned to the radio ID, bytes D, E, and F of the data packet in FIG. 2. Slave components, sensors and actuators, need to identify their control function. This is done with the device byte, G, in FIG. 2. Remember, slaves cannot communicate with each other in this master/slave protocol. Only masters can communicate with slave components. The actual control functions and communication requirements between sensors and actuators within the control system are established by the main controller. This is the primary control master and is identified by the primary control master bit in byte B of the data packet. Only control signals to actuators from the main controller identified by the primary controller master bit can be accepted by the actuator. If an extraneous device attempts to assume the main control function, both the slave device and the real main controller will see the ghost extraneous device. The real main controller can then take appropriate safety measures. Other types of masters are available to the control system, such as to meet the need for a repeater, a backup controller, or a computer monitor. They have special functions that are monitored by the main master. This illustrates the function of the operating system for this wireless control system.

There is a unique feature of this hardware and the operating system. In order to set up any component of the wireless system the device needs to be put into a timed setup mode. Only when the device is in setup mode can the operating parameters of the device be changed or set. In order to put the device into setup mode, the push button (S1 of FIG. 1), must be pushed. The LED (LED1 of FIG. 1) is then activated. The device is in setup mode for only a timed period. The setup is carried out through the computer master by sending the setup codes to the device being set up. One embodiment of this software is shown in FIG. 22, FIG. 23A and FIG. 23B. The computer, such as a PC, is connected to a standard USB to radio base station. This embodiment of the invention uses the Radiotronix Wi.USB-250 base station. When setting up a device in the control system, click on the INSTALL button on the software application. The setup menu is activated as shown in FIG. 23A. From this menu, click on the CONNECT button to establish communication with the device being setup. If the device is in setup mode, a communications link will be established to set up the device. The information shown in FIG. 23B becomes available. From simple pull up menus, the device can be properly set up. During any setup procedure, and as a security measure, the group ID will always be changed. A virgin device, when initially setting up the system, starts with a device ID of 0. This will be changed to the correct group ID when setting up the device. If an extraneous agent attempts to alter any parameter of the device, the device will be locked out of the system due to the altered group ID. This unauthorized infiltration of the system will set off alarms and put the entire system into safety shut down mode. Changing any one component within an activated system requires the changing of the group ID throughout the entire system. This is a safety feature designed into the operating system of the wireless control system.

This embodiment of this invention employs frequency hopping spread spectrum technology operating in the 900 MHz band with Y2 dipole antennas. The purpose is to promote a resistance to interference and jamming, unwanted signal interception, and good signal reception.

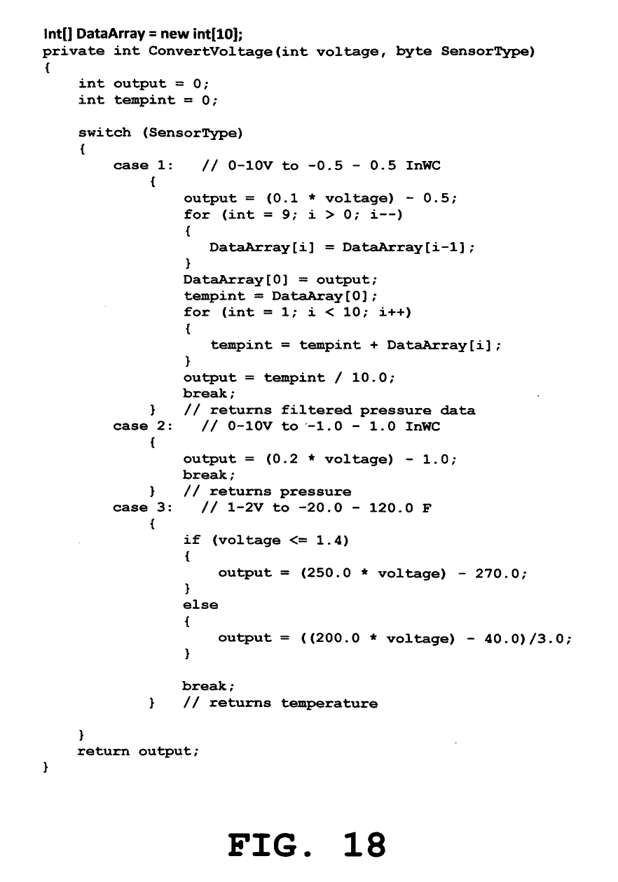

This embodiment of this invention employs distributed processing for all the control functions within the system. FIG. 18 shows the basic software or firmware architecture of this invention. There are many different possible types of functions that a sensor, actuator and controller can execute. The wireless operating system of this invention tracks the type of device associated with the data transmitted in the data packet. When setting up the control system, the device type number is set in the firmware of the device being set up. The code in the firmware of the device contains possible types of functions that the device would execute. The device number selects which one of all the possible functions that the device will execute. This is distributed function processing is different than the current practice of putting all functions into one processor and the using an RTOS or other operating system to sort out the correct operations. The distributed approach of this invention reduces the complexity of the actual control function and eliminates the need for a separate user interfaces for each installed device. In this invention all of the separate user interfaces were put into a single software application on a PC equipped with a wireless to USB base station.

For the case of this invention, a wireless interface became practical if the focus changed from the wires to the connectors on the circuit board for a wired application. Start not by replacing the wires, but with replacing the connectors. The next piece was the nature of the information transmitted over a wireless connection. In a wired connection, there are integrated control signals employed by a controller to carry out some control function. The key is the integration of all the component control functions: sensor(s), controller and actuator(s), which is done through the wired connection and the associated interface circuitry. The communication means over the wireless connection needed to do the same thing. The next, novel step was the integration of all the component control functions through the wireless connection via some form of operating system. It is not the radio connection itself, of which there are many currently available, but the nature of the information transmitted over the radio connection. In essence, the means for establishing the information exchange within the wireless connection would need to do for the wireless control system what the Microsoft Windows operating system does for personal computers and computer networks.

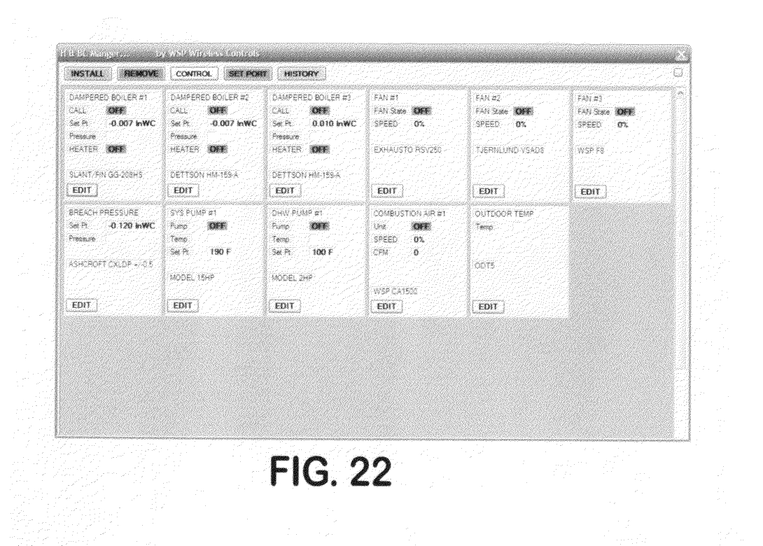

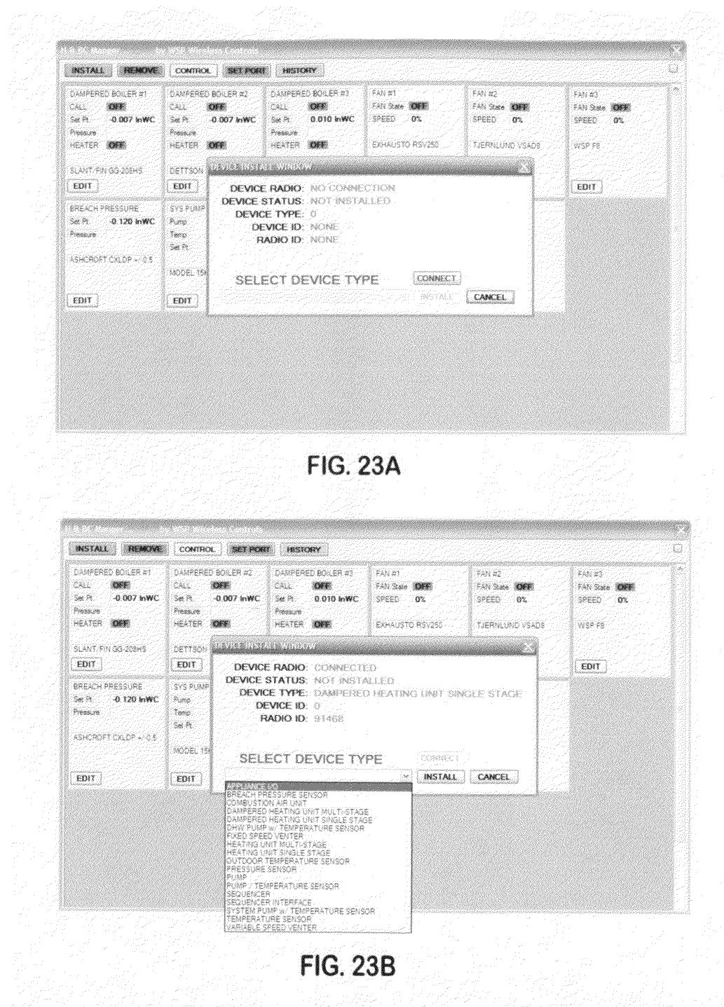

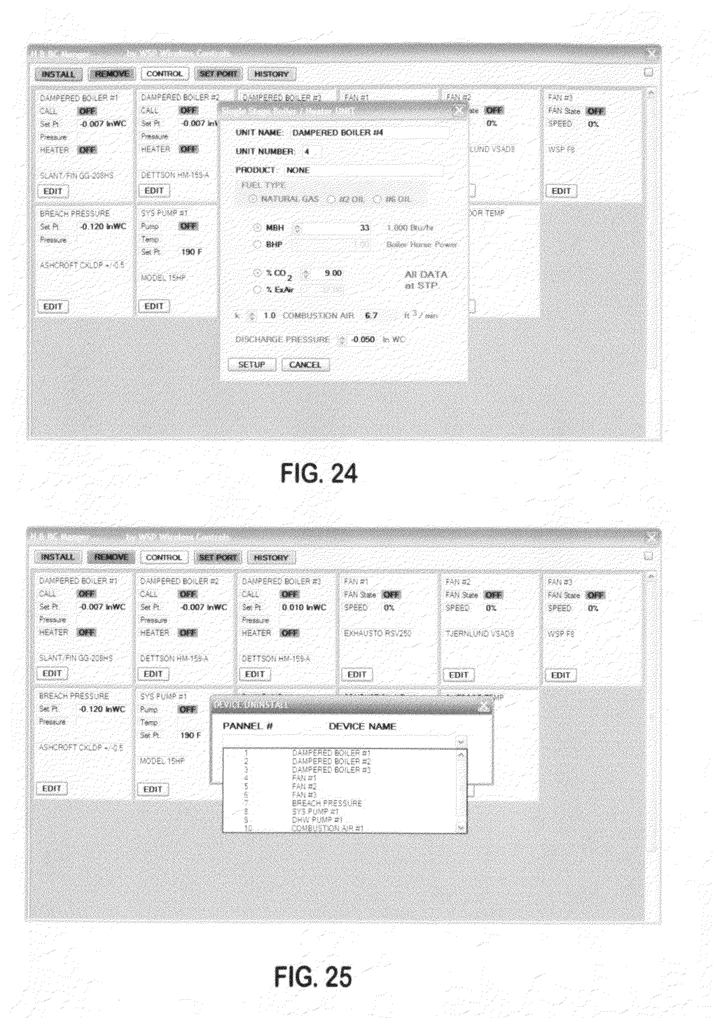

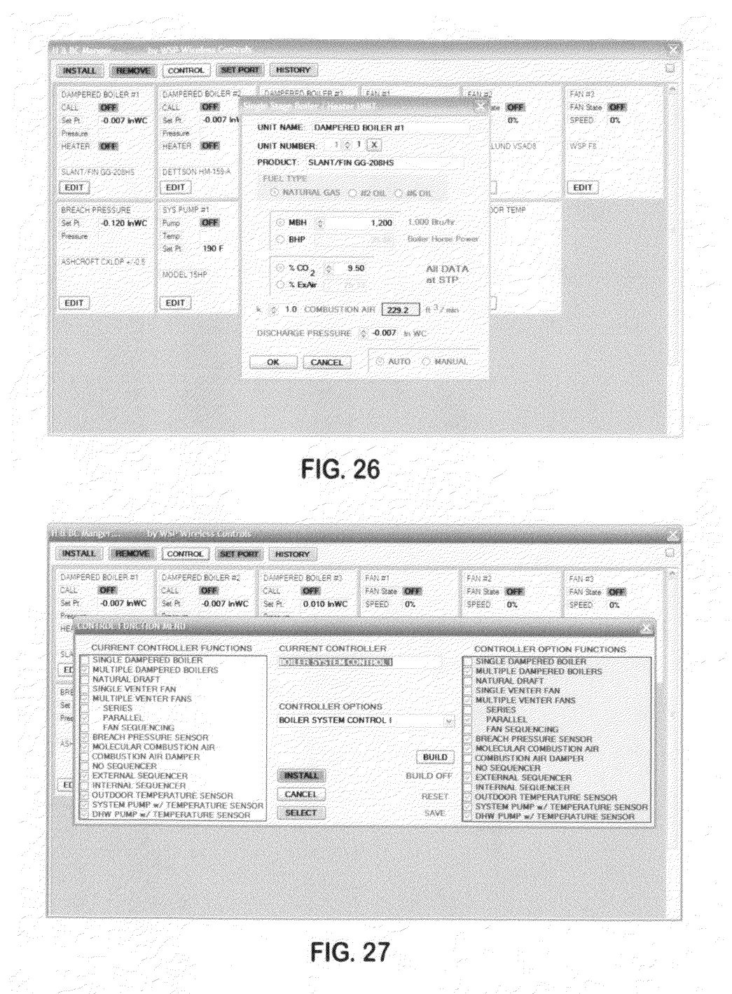

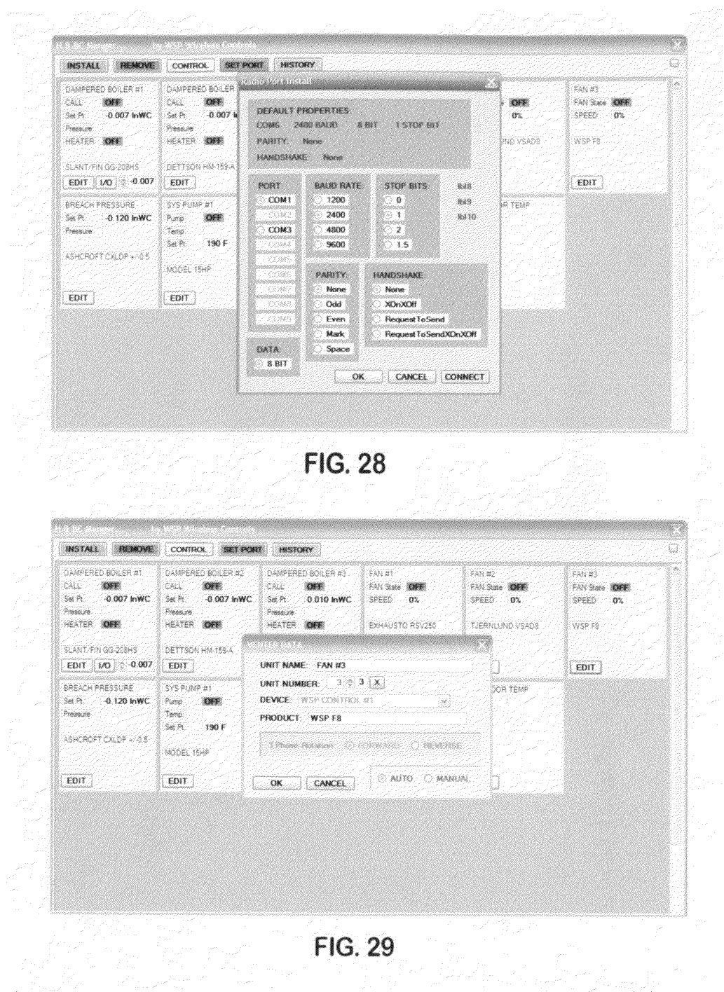

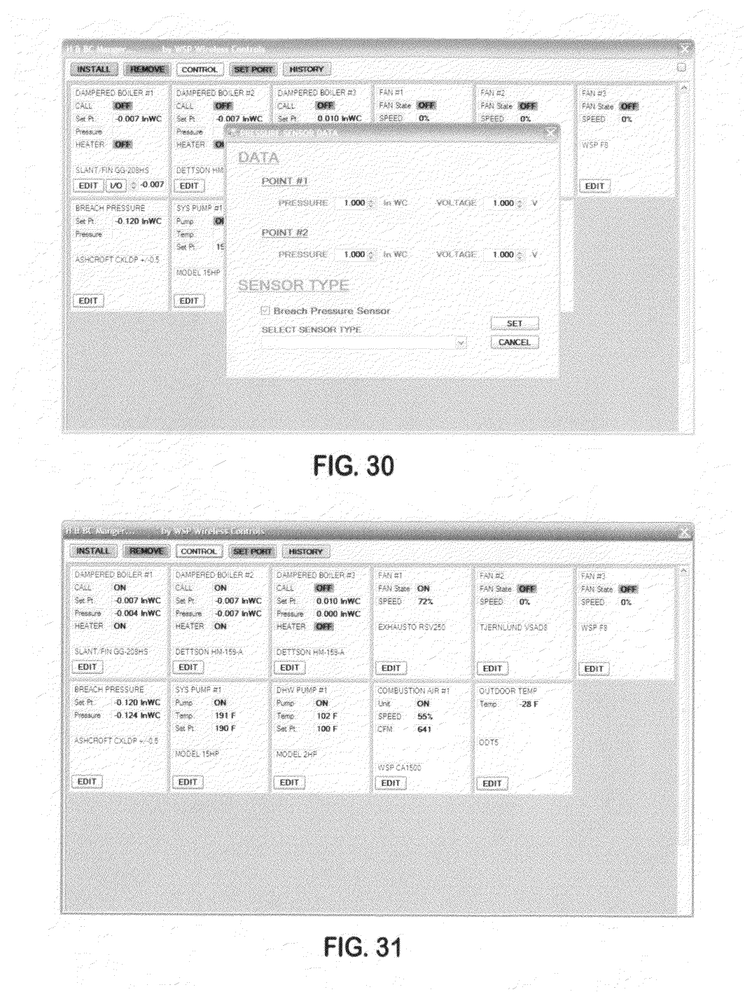

Wired components require a user interface that is always present in the system. This invention obviates that need. Instead, a computer user interface that was not required for the operation of the wireless control system is included. It is used to set up the system, and to monitor activity as desired. FIG. 24 through FIG. 31 illustrates features of the software designed for this wireless control system.

From the description above, a number of advantages and unique features of some embodiments of the general purpose wireless control system become evident. The example system in FIG. 3 will help describe these features:

1) The first novel feature is something we call inherent redundancy. Many processes incorporating control systems are mission critical by nature, and require a backup system. The boiler heating plant in a hospital is an example of such a mission critical application. A backup system is referred to as system redundancy. The boiler plant example in FIG. 3 employs mechanical combustion venting. This is accomplished with a venting fan, as opposed to the use of natural draft venting. Natural drafting employs no mechanical parts, as opposed to mechanical venting which uses a fan. Because it uses mechanical parts, mechanical venting is open to component failure within the system, which could result in the complete shutdown of the entire heating system as a safety issue. This is not tolerable in a mission critical application such as a hospital heating system. In this case, two heating systems are often installed with one always available as a backup in case of failure. In a typical wired application, there is only one control signal to the fans of the venting system. They operate in parallel. It is not practical for a wired system to include essentially unlimited independent connections with separate connectors on a single controller board. Because of this, any failure within the venting system takes down the entire system. The only available method for safe guarding a system failure is to include a separate backup system. That is current practice. The radio connection with the wireless operating system of the wireless control system of this invention provides multiple independent signal paths as opposed to the single signal path of current wired systems. This is inherent to this invention. As an example, if a venting system requires two fans (316 and 317 of the example in FIG. 3), all that is required for backup is one more fan (318 of the example in FIG. 3). There is no need for two completely separate systems. The multiple independent signal paths created by this invention create inherent redundancy. This is of considerable importance and significance in the design and operation of control systems, particularly in mission critical applications.

2) Another novel feature of this invention is distributed processing. As currently practiced, the sensing, actuator, and control functions are all combined into one processing machine. They often use an RTOS or some other form of operating system in an attempt to synchronize these functions. Because of the complexity of this approach, these systems are difficult to program and debug. They can have errors difficult to detect, and are prone to intermittent problems. With the wireless operating system of this invention, and the individual processing machines of the hardware in this invention, it is possible to install the separate sensing, actuator, and control processes into their individual devices. This greatly simplifies the design and implementation of any control system.

3) Another novel feature of this invention which has taken on paramount importance to customers today is immunity from cyber attacks. Because of the feature afforded in FIG. 1, the distributed processing functions, and the structure and function of the wireless operating system one cannot launch a cyber attack against his wireless control system.

4) Another novel feature of this invention is what we call device independence. Refer to the example of FIG. 3. In current practice, all of the control functions for the stabilizing dampers (305, 306, 307) and the fans (316, 317, 318) would originate from the controller itself. In a control sense, these devices are actuators. All of the necessary functions needed to operate the damper mechanism, including safety features, to operate the boilers (302, 303, 304) as part of the stabilizing damper, to operate the venting fans originate with the controller. With this wireless invention, all of these control functions associated exclusively with the individual device can be incorporated into the wireless interface of that device as simple firmware code. Remember, as shown in FIG. 21 all that is required for the device to execute its function is the simple control signal, without all of the associated individual functions required to be executed by the device. The devices exhibit a functional independence. We call this feature device independence.

An extension of this device independence is shown with the pump/temperature sensor devices (308, 309) of the example in FIG. 3. This particular device is a combination sensor and actuator. Because of the layout of a hydronic control, it is convenient and efficient to combine the pump and temperature sensing of the heating fluid into one simple device with one radio connection. As a result of the wireless operating system of this invention, that these are two slave functions, and the feature of device independence, it is possible to combine these sensor/actuator functions into one physical device. The schematics of FIG. 13 through FIG. 16 are schematics for such a device.

5) Another novel feature of the invention of this general purpose wireless control system is what we call open limits connectivity. For a wired system, there are practical limits to the number, function and type of connectors that can be incorporated onto the circuit board. This limits the applications of any controller designed for wired applications, because of these connector limitations. With the wireless connections that replace the wired connectors (not simply the wires) these limitations are removed. This feature in combination with the distributed processing function allows for the simplification of complex control functions in a controller. In addition, ready and reliable multiple control functions can easily be incorporated into one simple controller. This is illustrated in the single controller 320 of FIG. 3. Using the techniques of this invention, the controller 320 replaces all of the separate individual controllers with the separate complex control functions as currently practice in this industry.

6) Readily upgradeable products with both forward and backward compatibility. Reduce the number of models from more efficient use of resources.

7) The operating system allows for impostor detection protocol.

8) Individual safety features can readily be incorporated into the individual components of the control system enhancing the safety capabilities of the control system.

9) The wireless operating system of this invention provides system independency. If another separate wireless control system using the same physical radio system as an existing wireless control system, the group ID and device ID feature of the wireless operating system will keep them separate. This allows multiple, separate, independent control systems to operate in the same radio environment without interference.

10) The code architecture of this invention illustrated in FIG. 18 allows any or all components, individually or in total, within the system to be readily upgraded without affecting previously installed components in a system due to both forward and backward compatibility by simply adding new case statements and identifying them in the system with new type numbers.

### CONCLUSION, RAMIFICATIONS, AND SCOPE

Accordingly, the reader will see that the general purpose wireless control system of the various embodiments solves numerous problems associated with the design and implementation of control systems. Many examples of the novel benefits of this invention have been presented.

Although the description above contains many specificities, these should not be construed as limiting the scope of the embodiment but as merely providing illustrations of some of the presently preferred embodiments

Thus, the scope of the embodiment should be determined by the appended claims and their legal equivalents, rather than by the examples given.

I claim:

1. A general purpose wireless control system, comprising:
a.) a wireless sensor,
b.) a wireless actuator,
c.) a wireless controller,
d.) a master/slave protocol for the radio network, and
e.) a wireless operating system to facilitate secure communication over the wireless network.

2. The general purpose wireless control system incorporating a software application for monitoring the control system.
